(19) United States
(12) Patent Application Publication
(10) Pub. No.: US 2025/0276832 A1
(43) Pub. Date: Sep. 4, 2025

(54) LID AND CONTAINER ASSEMBLY AND MECHANISM FOR INTERCONNECTING THE LID TO THE CONTAINER

(71) Applicants: Tyler Phillips, Germantown, MD (US); William Stefany, Gaithersburg, MD (US)

(72) Inventors: Tyler Phillips, Germantown, MD (US); William Stefany, Gaithersburg, MD (US)

(21) Appl. No.: 19/211,408

(22) Filed: May 19, 2025

(51) Int. Cl. B65D 43/12; A01K 5/02; A01K 7/00

(52) U.S. Cl. CPC B65D 43/12; A01K 5/0225; A01K 7/00; B65D 2251/06; B65D 2251/10

(57) ABSTRACT

A lid and container assembly is provided. The assembly includes a container body and lid. In an embodiment, an exterior surface of a pair of side walls of the container body includes a track extending along a longitudinal axis. An interior surface of a pair of longitudinally extending side walls of the lid includes a projection extending along a lateral axis. Each of the tracks is closed at its two ends. The projections are received within the corresponding track to allow the lid to slide along the length of the track and abut against its two closed ends to facilitate opening the lid in two different configurations.

### FIELD OF THE INVENTION

The present invention relates to the field of animal husbandry, specifically to devices and apparatuses designed for feeding and watering animals. More particularly, the present invention relates to a lid and container assembly and a method for interconnecting the lid to the container to allow the lid to open in two different configurations for filling up the container with animal feed or water.

### BACKGROUND

In the context of animal husbandry, providing a reliable and efficient feeding and watering system is crucial for maintaining the health and well-being of animals. Animals such as chickens, rabbits, and other small livestock are often kept inside or outside enclosures. These enclosures necessitate the use of feeders and water containers to ensure easy access for the animals. Thus, it is essential to keep them filled up regularly. Most of these containers have a screw lid or a removable lid to allow filling them with feed or water.

Traditionally, various types of lid and container configurations have been invented. For example, U.S. Pat. No. 9,783,345B2 describes a sliding lid that is configured to slide onto the flanged edge of a food container. The sliding lid for the food container includes first and second flanged edge portions on opposing sides of its opening. The sliding lid includes a first and second flange-receiving channels configured to slidably receive the flanged edge portions of the food container from an open position, in which the opening of the container is uncovered, to a closed position, in which the main lid panel covers the opening of the container.

US20150232261 describes a container rod-shaped item, with a box and a lid. The box comprises an opening at the top. The container further includes a sheet-like connecting means connected to the lid, wherein the sheet-like connecting means is arranged vertically slidable relative to the box, such that the lid and the connecting means are movable from a lower position to an upper position. The connecting means is adapted to vertically lift at least one rod-shaped item by a predetermined distance when the lid is moved from the lower position to the upper position.

U.S. Pat. No. 11,905,077B2 describes containers of varying sizes with a slidable lid that is pivotable around the container. The storage container has one or more elements to hold the lid to the container, which may be unfastened so the lid may be removed from the container. The storage container has one or more side latches that may further hold the lid securely to the storage container.

Although several lid and container assembly systems, such as a few presented above, have been proposed in the past, there is still a need for a novel lid and container assembly and a method for interconnecting the lid to the container to allow the lid to open with greater ease.

### BRIEF SUMMARY

The present invention provides a solution in the form of a container and lid assembly in which the lid is interconnected to the container such that the lid is able to open like any other conventional hingedly coupled lid and is also able to slidably open to reveal the opening of the container for filling the container with water, animal feed etc. The lid's arrangement is made such that it ensures no water enters the container during outdoor use.

Embodiments of the present invention discloses a lid and container assembly. The lid and container assembly includes a container body having a bottom, and an open top. The container body comprises a first side wall, a second side wall opposite the first side wall, a third side wall, and a fourth side wall opposite the third side wall, all extending upwardly from the bottom forming an internal storage space surrounded by the plurality of side walls.

In an embodiment, an exterior surface of the first side wall, and an exterior surface of the second side wall comprises a track extending along a longitudinal axis (L).

In an embodiment, an exterior surface of the first side wall, and an exterior surface of the second side wall comprises a projection extending along a lateral axis (L′).

According to the embodiments presented, lid and container assembly further includes a lid comprising a top wall, a pair of longitudinally extending side walls, and a pair of laterally extending side walls extending downwardly from the top wall.

In an embodiment, the interior surface of each of the pair of longitudinally extending side walls comprises a track extending along a longitudinal axis (L) or a projection (102f) extending along a lateral axis (L′).

In an embodiment, each of the tracks of the container body is closed at its two ends. In an embodiment, each of the projections is received within the corresponding track and capable of sliding along the length of the track and abutting against the two closed ends to allow opening of the lid in a first configuration, and a second configuration.

In an embodiment, the track or the projection present on the exterior surfaces of the first side wall, and the second side wall in located in proximity to the open top of the container body.

In an embodiment, the track or the projection present on the interior surfaces of the pair of longitudinally extending side walls is located in proximity to the bottom end of the longitudinally extending side walls.

In an embodiment, the track is a linear track.

In an embodiment, the track is a non-linear track. The non-linear track is substantially L-shaped with a first portion of the track extending in a vertical direction (V) and a second portion extending in a longitudinal direction (L). The first portion of track extending vertically allows the lid to move downward with respect to the container body, thereby sufficiently sealing the open top of the container for preventing entrance of water.

In an embodiment, the track is formed from a pair of walls that meet at their respective ends to form the track with a first closed end and a second closed end.

In an embodiment, the lid is opened in the first configuration by rotating the lid in an anticlockwise direction. The lid is rotated in the anticlockwise direction to open the lid in the first configuration, the projections of the lid abuts against the first closed end of the track.

In an embodiment, the lid is opened in the second configuration by moving the lid upwardly in a vertical direction (V) along the first portion of the track, then sliding the lid along the longitudinal direction (L) along the second portion, and rotating the lid in a clockwise direction. When the lid is in the second configuration, the projections of the lid abuts against the second closed end of the track.

In an embodiment, at least one of the first side wall, the second side wall, the third side wall, and the fourth side wall comprises an opening to facilitate installation of at least a spout, a drinking cup, and a feeder port.

In an embodiment, a laterally extending side wall of the pair of laterally extending side walls is smaller in width compared to the laterally extending side wall to facilitate the lid to open in the anticlockwise direction, when the lid is opened in the first configuration.

In an embodiment, the diameter (d) of the projection engaged within the track for slidable operation is smaller compared to the width (W) of the track to accommodate the projection within the track.

### BRIEF DESCRIPTION OF THE ACCOMPANYING DRAWINGS

Example embodiments of the present invention will now be illustrated with reference to the following figures in which:

FIG. 1 is a diagram that illustrates a lid and container assembly with the lid capable of opening in two different configurations, in accordance with an exemplary embodiment of the present invention.

FIG. 2 is a diagram that illustrates the lid and container assembly of FIG. 1 in an exploded view.

FIGS. 3 and 4 are diagrams that illustrate side views of a container portion of the lid and container assembly of FIG. 2.

FIGS. 5 and 6 are diagrams that illustrate a rear view and a bottom perspective view of a lid portion of the lid and container assembly of FIG. 2.

FIG. 7 is a diagram that illustrates a cross-sectional view of the lid and container assembly of FIG. 1 taken along AA.

FIG. 8 is a diagram that illustrates a lid and container assembly with the lid capable of opening in two different configurations, in accordance with another exemplary embodiment of the present invention.

FIG. 9 is a diagram that illustrates a bottom perspective view of the lid portion of the lid and container assembly of FIG. 8.

FIGS. 10-12 show the lid of the lid and container assembly of FIG. 1 being operated in two different configurations.

FIGS. 13-15 show sectional views of the lid and container assembly, specifically showing the lid configuration to prevent any water flow into the container, according to an embodiment of the present invention.

FIGS. 16 and 17 are diagrams that illustrate perspective and side views of a container portion of the lid and container assembly of FIG. 2, in accordance with an alternative embodiment.

FIG. 18 is a diagram that illustrates a lid and container assembly with the lid capable of opening in two different configurations, in accordance with another exemplary embodiment where the container and the lid assembly is differently sized and shaped.

FIG. 19 is a diagram that illustrates the lid and container assembly of FIG. 18 in an exploded view.

FIGS. 20 and 21 shows a rear view and a side view of a lid portion of the lid and container assembly of FIG. 18.

FIGS. 22-23 shows the opening of the lid of the lid and container assembly of FIG. 1 in two different configurations.

### DETAILED DESCRIPTION

As used in the specification and claims, the singular forms “a”, “an”, and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the figures may be exaggerated, relative to other elements, to improve the understanding of the present invention. There may be additional components described in the foregoing application that are not depicted in one of the described drawings. In the event such a component is described, but not depicted in a drawing, the absence of such a drawing should not be considered as an omission of such design from the specification.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. Unless stated otherwise, terms such as “first” and “second” are used to arbitrarily distinguish between the elements. Thus, these terms are not necessarily intended to indicate temporal or other prioritization of such elements. While various exemplary embodiments of the disclosed invention have been described below it should be understood that they have been presented for purposes of example only, not limitations. It is not exhaustive and does not limit the invention to the precise form disclosed. Modifications and variations are possible considering the above teachings or may be acquired from practicing the invention, without departing from the breadth or scope.

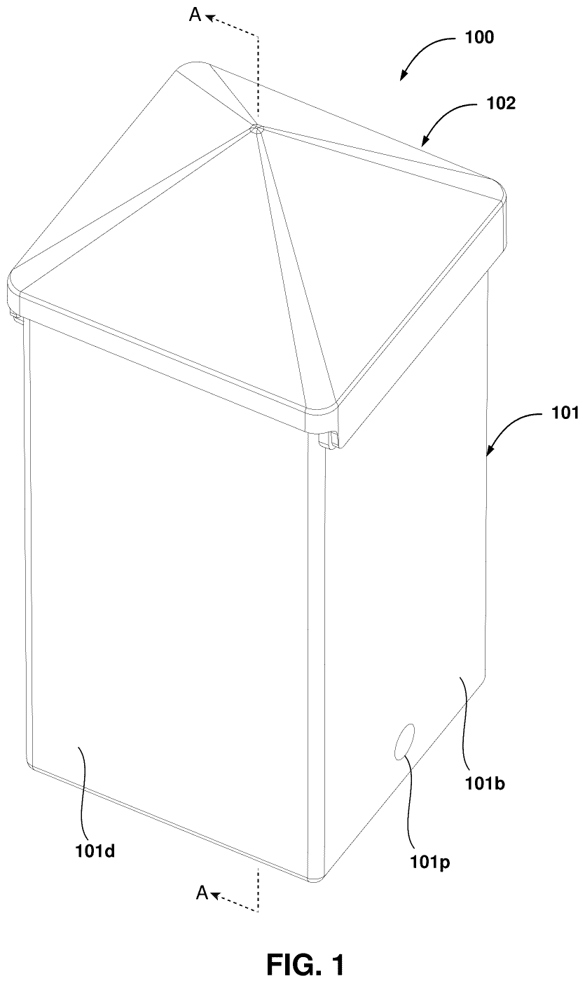

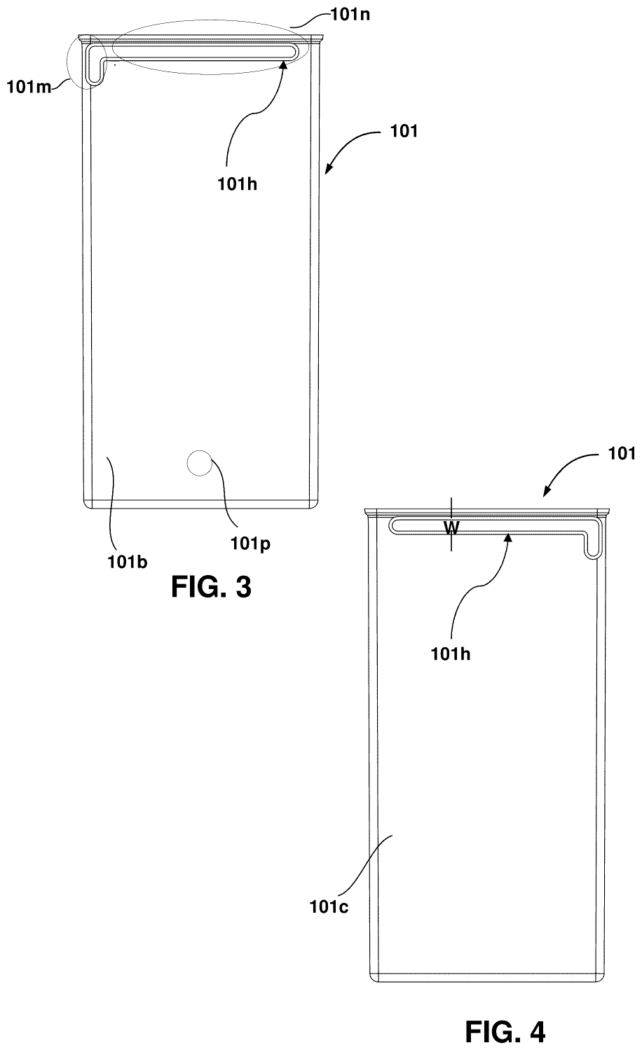

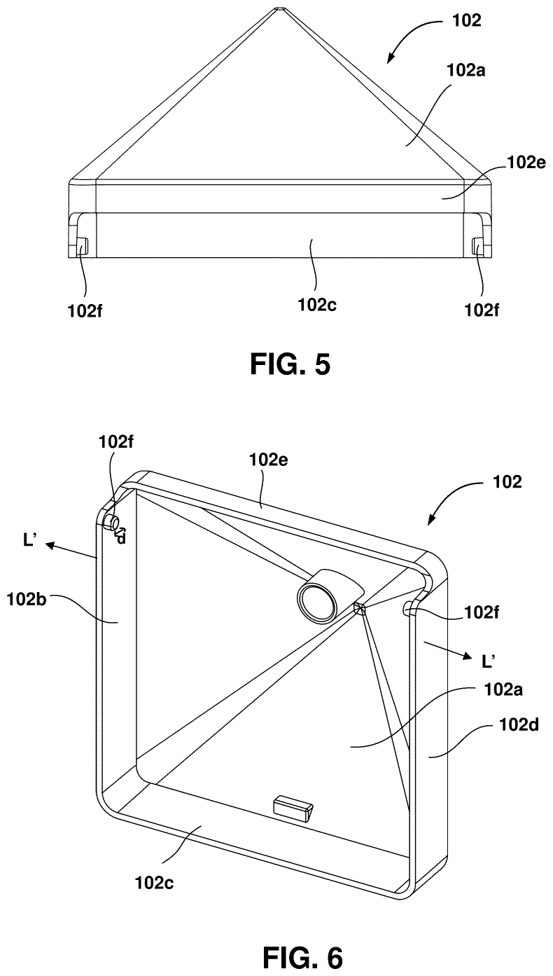

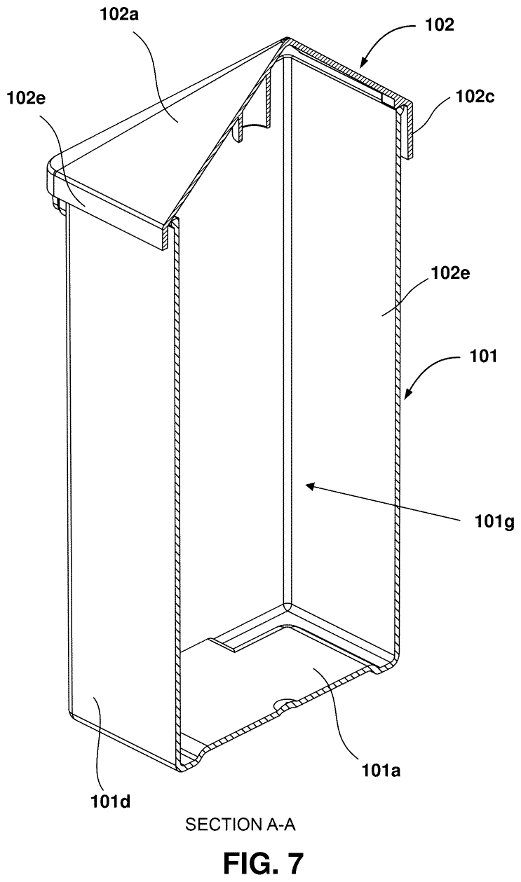

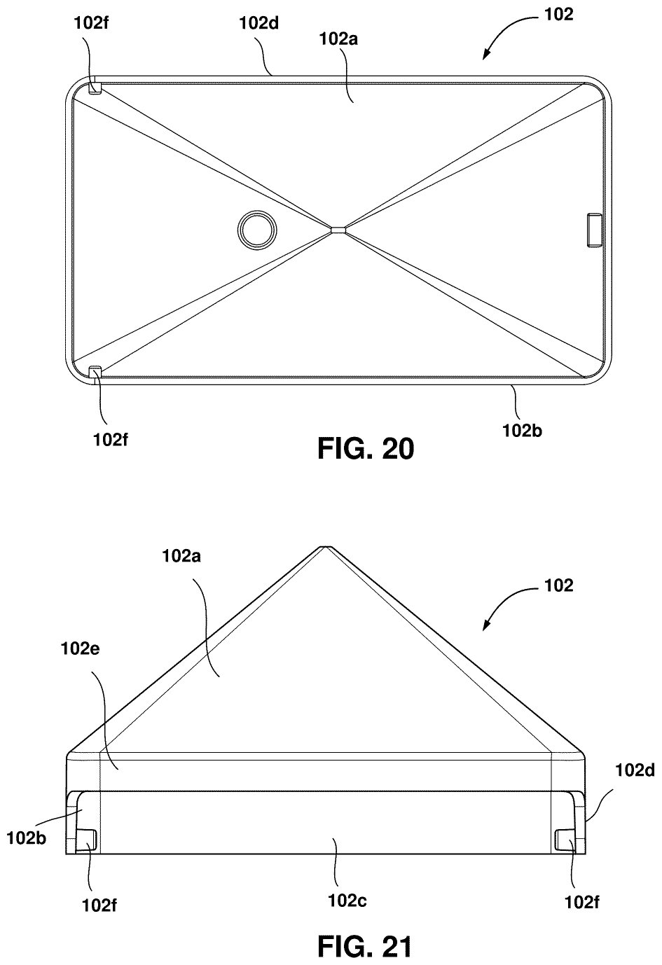

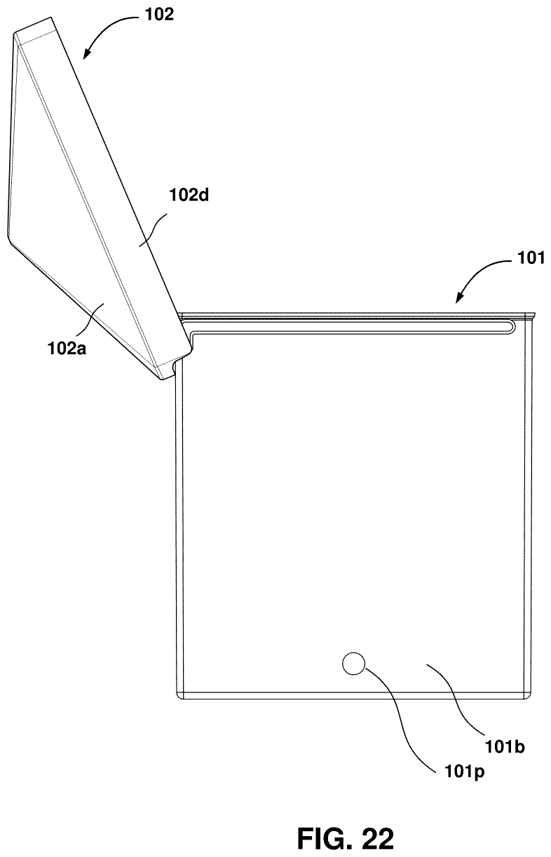

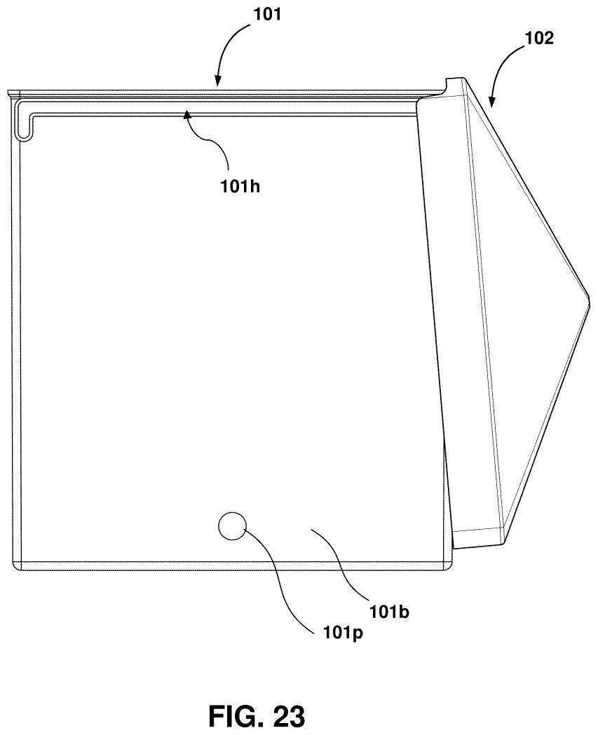

Before describing the present invention in detail, it should be observed that the present invention utilizes a combination of components or set-ups, which constitutes a lid and container assembly and a method for interconnecting the lid to the container to allow the lid to open in two different configurations for filling up the container with animal feed or water. The invention will now be described with reference to the accompanying drawings, specifically FIGS. 1-23, which should be regarded as merely illustrative without restricting the scope and ambit of the present invention.

Referring to FIGS. 1-7, a lid and container assembly with the lid capable of opening in two different configurations is shown, in accordance with an exemplary embodiment of the present invention.

The lid and container assembly 100 includes a container body 101 and a lid 102 placed thereon or coupled thereon. The container body 101 includes a plurality of side walls 101b-101e, namely a first sidewall 101b, a second sidewall 101c opposite the first side wall 101b, a third sidewall 101d, a fourth sidewall 101e opposite the third side wall 101d, all extending upwardly along the vertical direction (V) from the bottom 101a forming an internal storage space 101g surrounded by the side walls 101b-101e. The top end of the container 101 has an open top 101f. The container body 101 includes a closed bottom 101a.

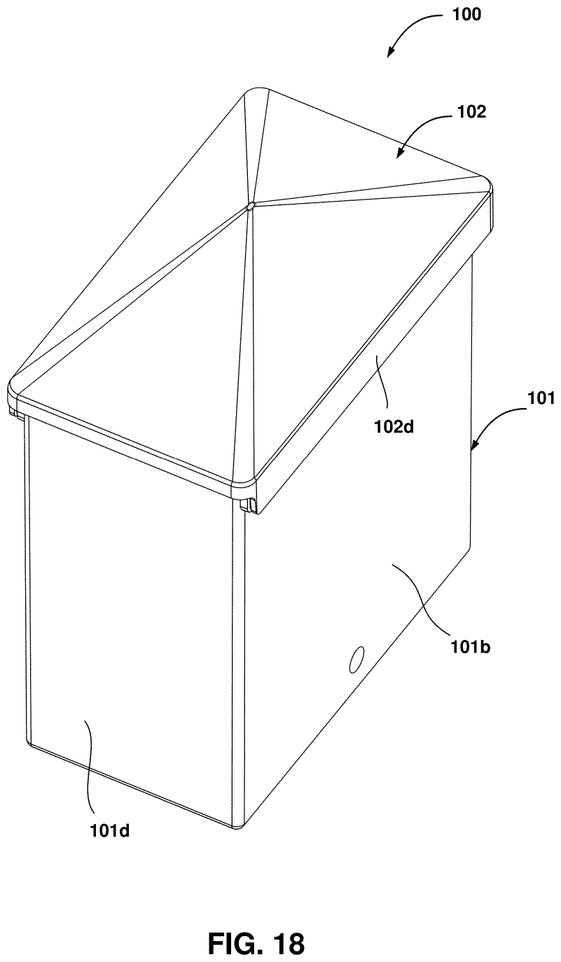

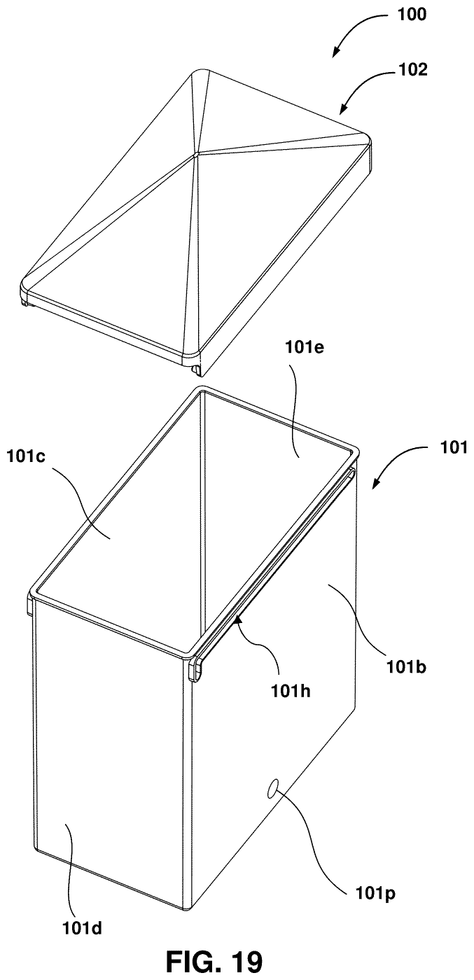

In an embodiment, as seen in FIGS. 1-4, the side walls 101b-101e forming the container body 101 are identically shaped and sized. In an example, the container body 101 so formed may be a 1-liter container. However, it should be understood that the side walls 101b-101e forming the container body 101 may be differently shaped and sized, such as shown in another embodiment (FIGS. 18-19). The size and shape of the side walls 101b-101e would preferably define the volume of the container 101 to hold water or feed within the internal storage space 101g of the container 101. In an example, the container body 101 so formed may be a 2-liter container as shown in FIGS. 18-19.

The container body 101 may be formed in many different forms depending upon the purpose of the container 101. In an embodiment, the side walls 101b-101e may be fully closed from all sides without any kind of holes/openings. In another embodiment, as seen in FIGS. 1-4, one or more of the side walls 101b-101e, say the sidewall 101b may include an opening 101p. In an example, the opening 101p may be used for installation of drinking cups, spouts, etc. if the container 101 is meant to be used as drinker and/or the opening 101p may be used for the installation of feeder ports if the container 101 is meant to be used as a feeder for the animals. Although only one opening is seen present on the container body 101, it should be understood that any number of openings may be present at different locations of selected sidewalls 101b-101e. In the example embodiments shown in this disclosure, the container and lid assembly 100 is meant to be used as a drinker or feeder. However, it should be understood that the concept can be applied to other baskets, or other kinds of containers, boxes, or similar products that may be used in any other field.

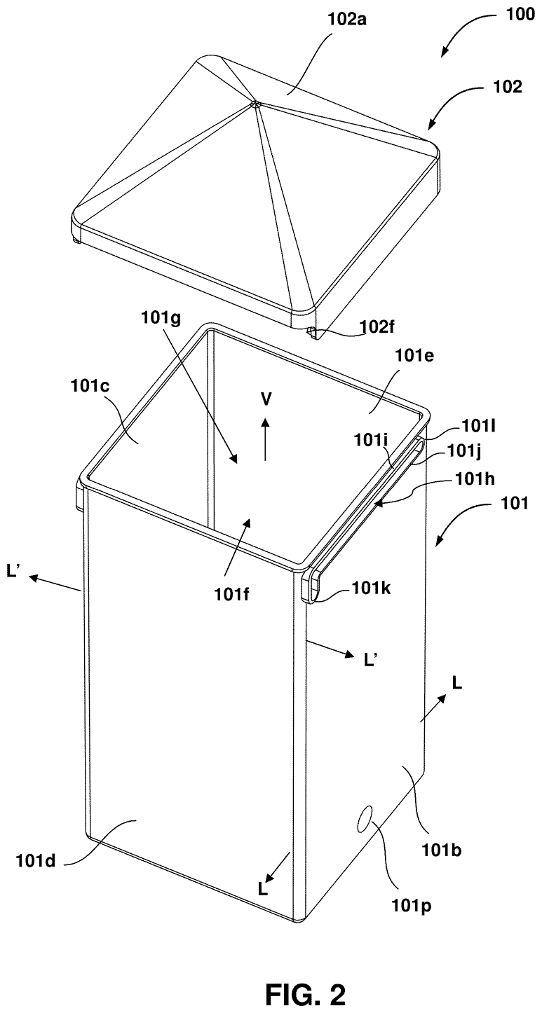

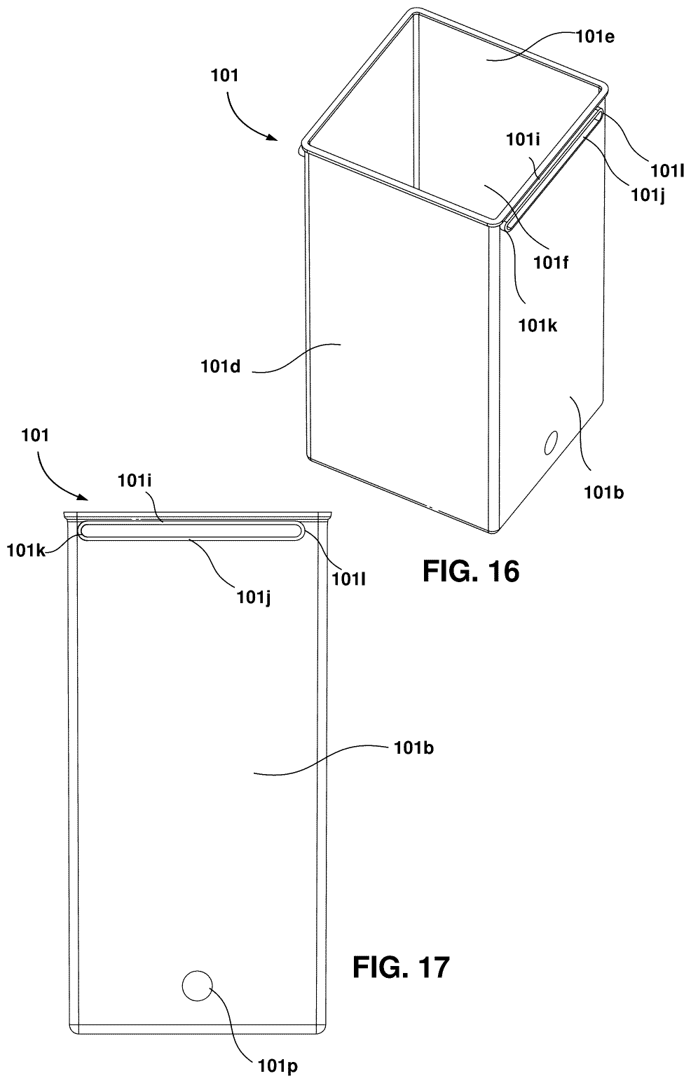

In an embodiment, as seen in FIGS. 1-7, an exterior surface of the side wall 101b, and an exterior surface of the side wall 101c include a track 101h formed thereon. The track 101h extends along a longitudinal axis (L). The track 101h may extend along the entire longitudinal length or partially along the longitudinal length. FIG. 2 specifically shows the orientation of the track 101h. The track 101h is located in proximity to the open top 101f (on sidewalls) of the container body 101. In an embodiment, as seen in FIGS. 16-17, the track 101h may be a linear track. The linear track 101h is formed using a pair of walls 101i,101j that meet at their respective ends to form the track 101h with two closed ends 101k, 101l. In a preferred embodiment (FIG. 2), the track 101h may be a non-linear track. The non-linear track 101h is formed using the pair of walls 101i, 101j that meet at their respective ends to form the track 101h with two closed ends 101k,101l, however the non-linear track 101h includes two portions: a first portion 101m of the track 101h extending downwardly in a vertical direction (V), and a second portion 101n extending in a longitudinal direction (L). The non-linear track is substantially L-shaped, formed by the first portion 101m and the second portion 101n. The track 101h may extend along the entire length or partially along the length (longitudinal length) of the container 101 depending upon the size of the opening of the container body 101 desired.

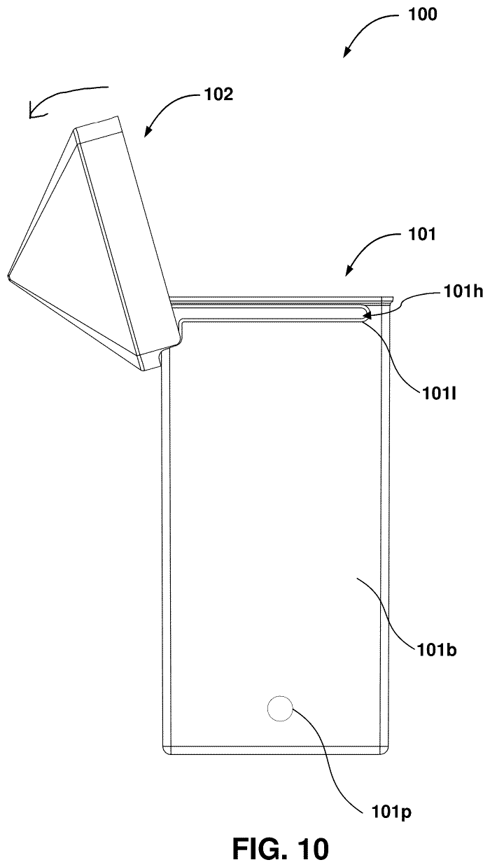

In an embodiment, as seen in FIGS. 1-2, 5-7, the lid and container assembly further include a lid 102 that couples onto the container body 101 to cover the open top 101f. The lid 102 includes a top wall 102a, and a pair of longitudinally extending side walls (102b,102d), a pair of laterally extending side walls (102c, 102e), all extending downwardly from the top wall 102a. As seen, the top wall 102a may be cone-shaped according to an embodiment. In some other embodiment, the top wall 102a may be flat or configured in another shape. A sidewall 102e of the pair of laterally extending side walls (102c, 102e) is smaller in width compared to the other sidewall 102c. This configuration of the wall 102e allows the lid 102 to restrictively open in an anticlockwise direction when the lid 102 is opened in the first configuration (FIG. 10). Further, as seen, the interior surface of each of the pair of longitudinally extending side walls (102b,102d) includes a projection 102f extending along a lateral axis (L′) as seen in FIG. 6. These projections 102f of the lid 102 are strategically located and received within the track 101h on the exterior surfaces of the sidewalls 101b, 101c in order to engage the lid 102 on the container body 101 covering the open top 101f. As seen and can be understood by those skilled in the art, the diameter (d) of the projection 102f (FIG. 6) being engaged within the track 101h for slidable operation is smaller compared to the width (W) of the track 101h (FIG. 4) to accommodate the projection 102f within the track 101h. The projections 102f shown in the embodiment are cylindrical in shape, however it should be understood that the projections may be of any other shapes.

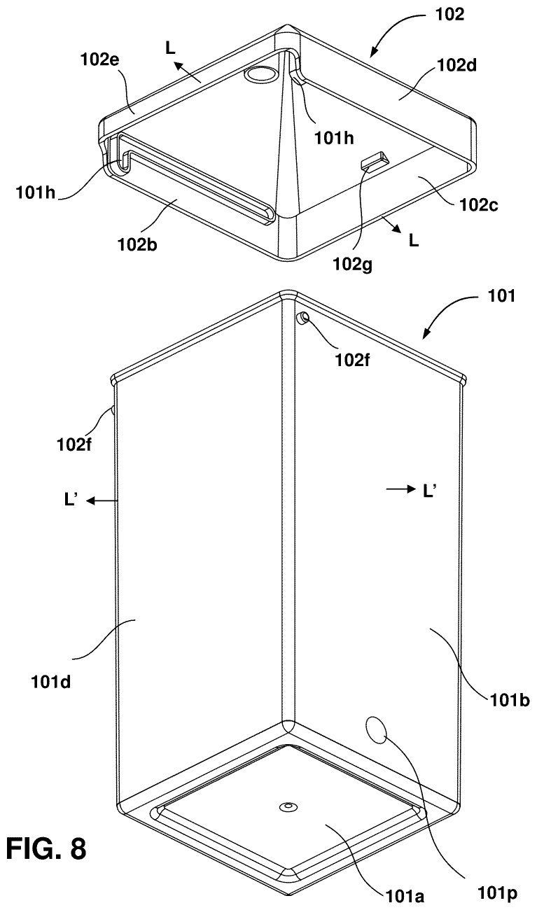

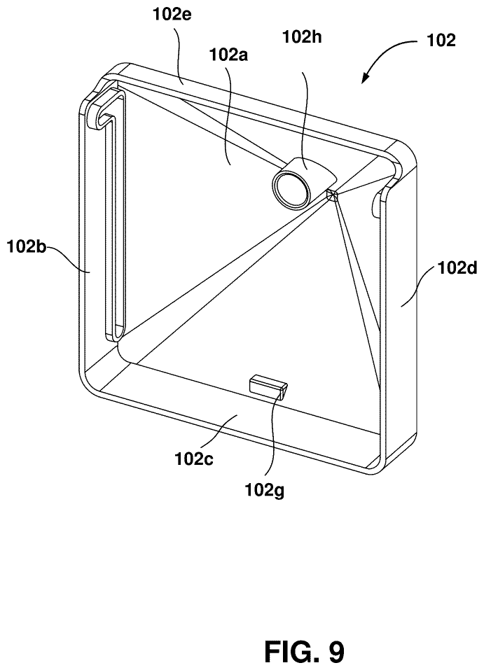

In contrast to the embodiment described above, where the tracks 101h are seen located on the exterior surfaces of the side walls 101b,101c and the projections 102f located on the side walls 102b,102d that slidably engages the tracks 102b,102d, there is possibility that the interior surface of each of the pair of longitudinally extending side walls 102b,102d to embody the tracks 101h and the exterior surfaces of the side walls 101b, 101c of the container body 101 to embody projections 102f as shown in FIGS. 8-9.

Referring to FIGS. 1 and 10-12, the operation of the lid 102 is shown. The lid 102 is coupled onto the container body 101 by engagement of the projections 102f (of the lid 102) into the tracks 101h (of the container body 101) or by engagement of the projections 102f (of the container body 101) into the tracks 101h (of the lid 101). During the closed position of the lid 102, the open top 101f of the container body 101 is closed by the top wall 102a of the lid 102, thereby restricting the access to the storage space 101g of the container body 101. In order to fill up the container 101 with water or feed or any other substances, the lid 102 can be operated by a user in two different ways, as shown in FIGS. 10-12.

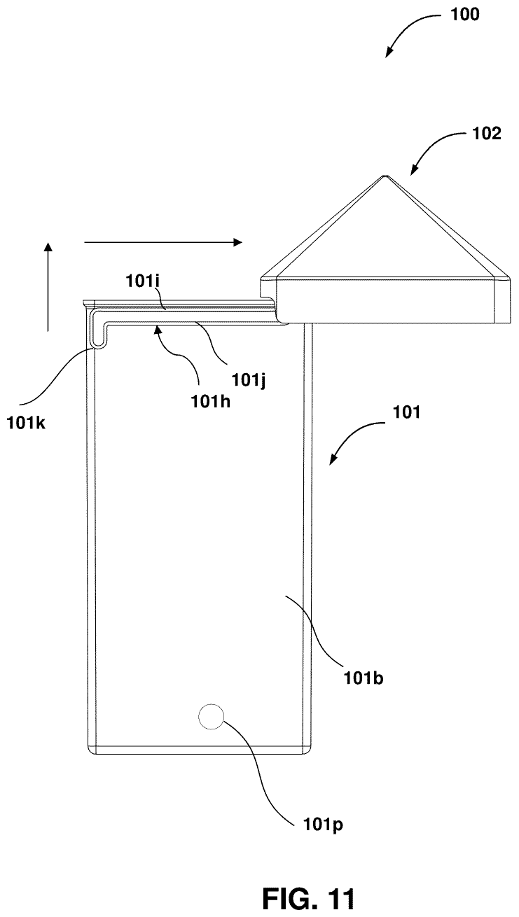

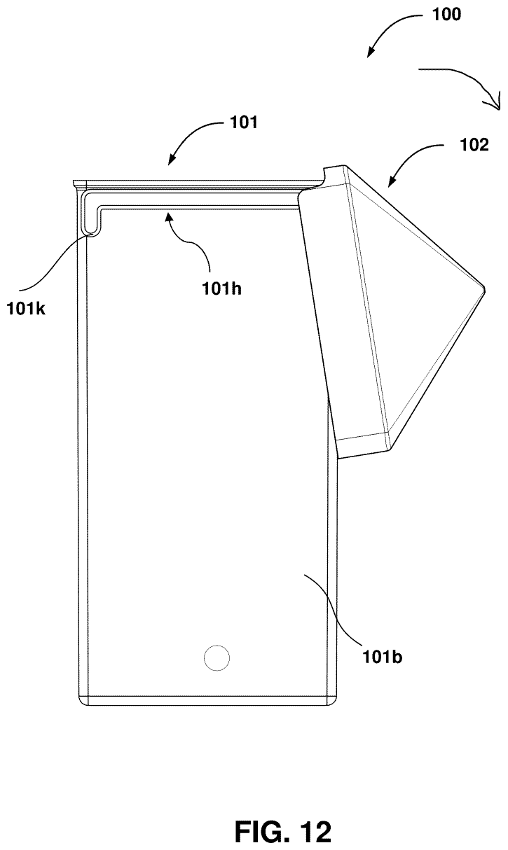

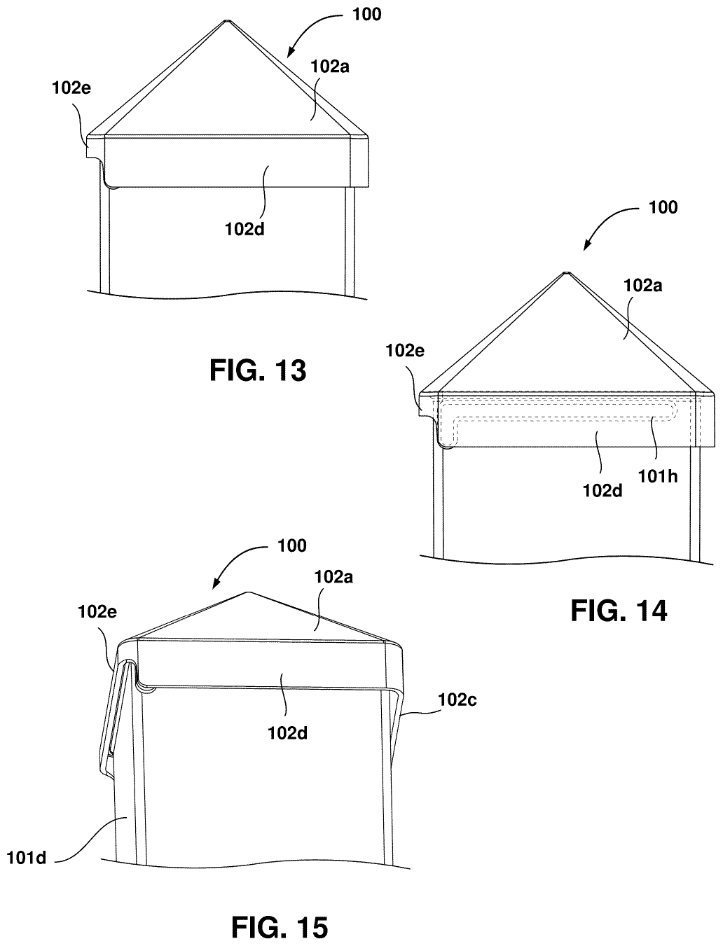

Firstly, the user is able to open the lid 102 by moving the lid 102 in an anti-clockwise direction as seen in FIG. 10. In this configuration, the projections 102f abut against the extreme closed end 101k of the track 101h. The projection 102f and track 101h combinations also allow the user to slidably open the lid 102 in a clockwise direction, as best seen in FIGS. 11-12. As seen in FIG. 12, when the lid 102 opens up by moving the lid 102 along the track 101h and rotating the lid 102 clockwise, then the projections 102f happen to abut against the other extreme closed end 101l of the track 101h. In the preferred embodiment shown in FIGS. 10-12, the track 101h happens to include L shaped track described above. In this track 101h, the lid 102 is not only slidably moved along the longitudinal direction (L) but is also required to move along vertical direction (V). In short, in the scenario where the track is L-shaped/non-linear, the lid 102 can either be opened just like any other conventional hinged lid (by simply rotating in the anticlockwise direction, as indicated by an arrow in FIG. 10) or may be required to be moved first in an upward direction and then in the longitudinal direction (L) and rotated the clockwise direction (as indicated by arrows in FIGS. 11-12) in order to open up the lid 102 as seen in FIG. 12. The lid 102 is designed to prevent entrance of water inside the container body 101. Specifically, in the L-shaped track 101h, the first portion 101m extending vertically allows the lid 102 to move slightly downward with respect to the container body 101, thereby sealing the open top 101f of the container 101 (for entrance of water) from the rear side at the top end of the side wall 101d as seen in close up views of the container and lid assembly 100 in FIGS. 13-15. Coming to the track 101h configuration (shown in FIGS. 16-17), the lid 102 is not allowed to move vertically due to the absence of the first portion 101m of the track 101h. In this configuration, although the lid 102 is able to operate in two ways to open up in two different configurations, the lid 102 does not make any vertical movement.

Turning back to FIGS. 8-9, the lid 102 of the container and lid assembly 100 includes a stopper 102g configured on the top wall 102a. The purpose of this stopper 102g is to rest the lid 102 onto the edge surrounding the open top 101f of the container 101 to keep the lid 102 leveled with respect to the container body 101. Similarly, the lid 102 may include a vent present on the top wall to keep the contained water/feed aerated for use. There may be a possibility that other accessories or design changes may be incorporated into the lid 102.

FIGS. 18-23 show an embodiment of the container and lid assembly 100, which is ideally similar to the container and lid assembly 100 shown and described above with respect to FIGS. 1-17 except the size and shape of the lid 102 and the container body 101. The embodiment of the container and lid assembly 100 in this embodiment is exactly the same as the embodiment shown in FIGS. 1-2, except the sidewalls 101b-101e of the container body 101 in FIG. 18 are different in size and shape. The detailed description for this embodiment is thus intentionally omitted for FIGS. 18-23. The sidewalls 101b,101c are bigger compared to the sidewalls 101d, 101e. In the example embodiment, the sidewalls 101b-101e are shaped and sized for a volume of 2 liters. However, it should be understood that the concept can be applied, and the walls 101b-101e can be variably shaped and sized depending upon the volume requirement of the container and lid assembly 100. All the alternative embodiments described with respect to FIGS. 1-2, 8-9,16-17 for 1 1-liter container and lid assembly 100 based on the shapes and location of the tracks 101h, the projections 102f are also applicable for the embodiment shown in FIGS. 18-23.

The foregoing descriptions of specific embodiments of the present technology have been presented for purposes of illustration and description. They are not intended to be exhaustive or to limit the present technology to the precise forms disclosed, and obviously many modifications and variations are possible considering the above teaching. The embodiments were chosen and described to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A lid and container assembly (100), comprising:
a container body (101) having a bottom (101a), and an open top (101f), wherein the container body (101) comprises
a first side wall (101b), a second side wall (101c) opposite the first side wall (101b), a third side wall (101d), and a fourth side wall (101e) opposite the third side wall (101d), all extending upwardly from the bottom (101a) forming an internal storage space (101g) surrounded by the plurality of side walls (101b-101e);
wherein an exterior surface of the first side wall (101b), and an exterior surface of the second side wall (101c) comprises a track (101h) extending along a longitudinal axis (L) or a projection (102f) extending along a lateral axis (L′);
a lid (102) comprising a top wall (102a), a pair of longitudinally extending side walls (102b,102d), and a pair of laterally extending side walls (102c, 102e) extending downwardly from the top wall (102a);
wherein the interior surface of each of the pair of longitudinally extending side walls (102b,102d) comprises a track (101h) extending along a longitudinal axis (L) or a projection (102f) extending along a lateral axis (L′); and
wherein, each of the tracks (101h) is closed at its two ends (101k,101l), and each of the projections (102f) is received within the corresponding track (101h) and capable of sliding along the length of the track (101h) and abutting against the two closed ends to allow opening of the lid (102) in a first configuration, and a second configuration.

2. The lid and container assembly (100) of claim 1, wherein the track (101h) or the projection (102f) present on the exterior surfaces of the first side wall (101b), and the second side wall (101c) in located in proximity to the open top (101f) of the container body (101).

3. The lid and container assembly (100) of claim 1, wherein the track (101h) or the projection (102f) present on the interior surfaces of the pair of longitudinally extending side walls (102b,102d) is located in proximity to a bottom end of the longitudinally extending side walls (102b,102d).

4. The lid and container assembly (100) of claim 1, wherein the track (101h) is a linear track.

5. The lid and container assembly (100) of claim 1, wherein the track (101h) is a non-linear track.

6. The lid and container assembly (100) of claim 1, wherein the track (101h) is formed from a pair of walls (101i, 101j) that meet at their respective ends to form the track (101h) with a first closed end (101k) and a second closed end (101l).

7. The lid and container assembly (100) of claim 5, wherein the non-linear track is substantially L-shaped with a first portion (101m) of the track (101h) extending in a vertical direction (V) and a second portion (101n) extending in a longitudinal direction (L).

8. The lid and container assembly (100) of claim 1, wherein the lid (102) is opened in the first configuration by rotating the lid (102) in an anticlockwise direction.

9. The lid and container assembly (100) of claim 8, wherein when the lid (102) is rotated in the anticlockwise direction to open the lid (102) in the first configuration, the projections (102f) of the lid (102) abuts against the first closed end (101k) of the track (101h).

10. The lid and container assembly (100) of claim 1, wherein the lid (102) is opened in the second configuration by moving the lid (102) upwardly in a vertical direction (V) along the first portion (101m) of the track (101h), then sliding the lid (102) along the longitudinal direction (L) along the second portion (101n), and rotating the lid (102) in a clockwise direction.

11. The lid and container assembly (100) of claim 10, wherein when the lid (102) is in the second configuration, the projections (102f) of the lid (102) abuts against the second closed end (101l) of the track (101h).

12. The lid and container assembly (100) of claim 1, wherein at least one of the first side wall (101b), the second side wall (101c), the third side wall (101d), and the fourth side wall (101e) comprises an opening (101p) to facilitate installation of at least a spout, a drinking cup, a feeder port.

13. The lid and container assembly (100) of claim 1, wherein a laterally extending side wall (102e) of the pair of laterally extending side walls (102c, 102e) is smaller in width compared to the laterally extending side wall (102c) to facilitate the lid (102) to open in the anticlockwise direction, when the lid (102) is opened in the first configuration.

14. The lid and container assembly (100) of claim 1, wherein the diameter (d) of the projection (102f) engaged within the track (101h) for slidable operation is smaller compared to the width (W) of the track (101h) to accommodate the projection (102f) within the track (101h).

15. The lid and container assembly (100) of claim 10, wherein the first portion (101m) of track (101h) extending vertically allows the lid (102) to move downward with respect to the container body (101), thereby sufficiently sealing the open top (101f) of the container (101) for preventing entrance of water.
